(19) United States
(12) Patent Application Publication
(10) Pub. No.: US 2014/0132161 A1
(43) Pub. Date: May 15, 2014

(54) Method for Using Constant Current Driving Chip to Generate Different Currents to Drive Light Bar and Driving Circuit Thereof

(71) Applicants: Hua Zhang, Shenzhen City (CN); Fei Li, Shenzhen City (CN)

(72) Inventors: Hua Zhang, Shenzhen City (CN); Fei Li, Shenzhen City (CN)

(73) Assignee: Shenzhen China Star Optoelectronics Technology Co., LTD., Shenzhen City, Guangdong Province (CN)

(21) Appl. No.: 13/807,719

(22) PCT Filed: Nov. 22, 2012
(86) PCT No.: PCT/CN2012/084997

§ 371 Date: Dec. 28, 2012

(30) Foreign Application Priority Data
Nov. 14, 2012 (CN) 201210457447.2

(51) Int. Cl. H05B 37/02

(52) U.S. Cl. CPC H05B 37/02
USPC 315/161

(57) ABSTRACT

The present invention provides a method for using a constant current driving chip to generate different currents to drive light bars and a driving circuit thereof. The method includes (1) providing LED light bars, a constant current driving chip, resistors having different resistances, and first and second power sources, wherein the driving chip has light bar connection terminals, resistor connection terminals, a power connection terminal, and a power grounding line connection terminal; (2) connecting positive and negative terminals of each LED light bar to the first power source and the light bar connection terminals; (3) connecting ends of each resistor to the resistor connection terminals and the grounding line; and (4) connecting the power connection terminal and the power grounding line connection terminal of the driving chip to the second power source and activating the power sources to drive the LED light bars to give off lights of different illuminations.

### BACKGROUND OF THE INVENTION

1. Field of the Invention

The present invention relates to the field of driving of LED (Light-Emitting Diode) light bar, and in particular to a method for using a constant current driving chip to generate different currents to drive light bars and a driving circuit thereof.

2. The Related Arts

LED is a solid state light source, which uses re-combination of electrons and electron holes in a semiconductor to emit photons. The color emitting from an LED is determined by the energy of photons and the energy of photons is determined by the material used. The same material gives substantially identical wavelength of the emitted light and thus, each LED gives off a pure color. The most commonly known LEDs of regular brightness include red color and green color. The LEDs have small sizes of die, have diversified colors, and provide significant flexibility in arrangement for use, these being the factors making them superior to the ordinary light source. Further, compared to the other light sources, the LEDs also provide relatively high light efficiency and relatively high reliability and the way of power supplying thereto is relatively simple. Thus, the LEDs are particularly fit to serving as a light source for displaying.

Similar to a PN junction of a regular semiconductor, voltage drop of forward conduction of an LED hardly varies with conduction current and is generally approximately 3.5V, but the illumination increases with the increase of the current flowing therethrough, so that the larger the current is, the larger the optic output and illumination will be. Thus, LEDs must use serially-connected power supply and a constant current power supply, so that the electrical current flowing through the diode is constant in order to maintain stable optical output. For a driving chip for LEDs, the output must feature constant current to power serially connected LEDs. Current setting of a conventional LED constant current driving chip (IC) is determined by resistance externally connected to a current setting pin of the chip. That means the current is equal to a constant voltage internally of the chip divided by the resistance and thus different resistances correspond to different currents. As shown in FIG. 1, in a conventional LED backlight driving circuit, the method of a constant current driving chip is relatively simple, where the resistances externally connected to the current setting pins of the chip are identical and thus, the currents are all the same even for different LED light bars and the illuminations so generated are identical. This method is not applicable to special occasions where different LED light bars are used to generate different illuminations for atmosphere making purposes.

Thus, the conventional LED driving technology shows the following shortcomings: The electrical currents for different LED light bars are identical and thus the illuminations generated thereby are identical. The constant current driving chip provides only a single way of use, making it not fit to special occasions.

### SUMMARY OF THE INVENTION

An object of the present invention is to provide a method for using a constant current driving chip to generate different currents to drive light bars, which can generate different electrical currents to drive LED light bars so as to make the LED light bars to generate mutually different illuminations and is applicable to various fields, such as backlight driving of liquid crystal display device and LED lighting, and is particularly applicable to various special occasions.

Another object of the present invention is to provide an LED light bar driving circuit, which can generate different electrical currents to drive LED light bars so as to make the LED light bars to generate mutually different illuminations and is applicable to various fields, such as backlight driving of liquid crystal display device and LED lighting, and is particularly applicable to various special occasions.

To achieve the objects, the present invention provides a method for using a constant current driving chip to generate different currents to drive light bars, which comprises the following steps:
(1) providing a plurality of LED light bars, a constant current driving chip, a plurality of resistors having different resistances, and first and second power sources, wherein the constant current driving chip comprises first to forty-first terminals, among which the ninth to sixteenth terminals are light bar connection terminals, the twenty-fifth to thirty-sixth terminals are resistor connection terminals, the first terminal is a power connection terminal, and the fifth terminal is a power grounding line connection terminal; each of the LED light bars has a positive terminal and a negative terminal;
(2) electrically connecting the positive terminal of each of the LED light bars to the first power source and electrically connecting the negative terminals of the LED light bars to the light bar connection terminals of the constant current driving chip, each of the ninth to sixteenth terminals of the constant current driving chip being connected to one of the LED light bars;
(3) electrically connecting an end of each of the resistors to the respective resistor connection terminal of the constant current driving chip and connecting an opposite end to the grounding line, each of the twenty-fifth to thirty-two terminals of the constant current driving chip being connected to one of the resistors; and
(4) electrically connecting the power connection terminal and the power grounding line connection terminal of the constant current driving chip to the second power source and activating the first and second power sources to drive the plurality of LED light bars to give off light.

The resistances of the plurality of resistors are determined according to the illumination of the LED light bar corresponding to each of the resistors.

The resistors are formed of variable resistors.

The LED light bars are of a number of 2-8 and the resistors have a number of 2-8 to correspond to that of the LED light bars.

The seventeenth to twenty-fourth terminals of the constant current driving chip are PWM control terminals. The PWM control terminals are externally connectable to control sources for controlling conduction or cutoff of the LED light bars.

The present invention also provides an LED light bar driving circuit, which comprises a plurality of LED light bars, a constant current driving chip, a plurality of resistors having different resistances, and first and second power sources. The constant current driving chip comprises first to forty-first terminals, among which the ninth to sixteenth terminals are light bar connection terminals, the twenty-fifth to thirty-sixth terminals are resistor connection terminals, the first terminal is a power connection terminal, and the fifth terminal is a power grounding line connection terminal. The plurality of LED light bars each has an end electrically connected to the first power source and an opposite end electrically connected to the respective light bar connection terminal. Each of the ninth to sixteenth terminals is connected to one of the LED light bars. The plurality of resistors each has an end electrically connected to the grounding line and an opposite end electrically connected to the respective resistor connection terminal. Each of the twenty-fifth to thirty-sixth terminals is connected to one of the resistors. The power connection terminal and the power grounding line connection terminal are electrically connected to the second power source.

The resistances of the plurality of resistors are determined according to the illumination of the LED light bar corresponding to each of the resistors.

The resistors are formed of variable resistors.

The LED light bars are of a number of 2-8 and the resistors have a number of 2-8 to correspond to that of the LED light bars.

The seventeenth to twenty-fourth terminals of the constant current driving chip are PWM control terminals, the PWM control terminals being externally connectable to control sources for controlling conduction or cutoff of the LED light bars.

The present invention further provides a method for using a constant current driving chip to generate different currents to drive light bars, which comprises the following steps:
(1) providing a plurality of LED light bars, a constant current driving chip, a plurality of resistors having different resistances, and first and second power sources, wherein the constant current driving chip comprises first to forty-first terminals, among which the ninth to sixteenth terminals are light bar connection terminals, the twenty-fifth to thirty-sixth terminals are resistor connection terminals, the first terminal is a power connection terminal, and the fifth terminal is a power grounding line connection terminal; each of the LED light bars has a positive terminal and a negative terminal;
(2) electrically connecting the positive terminal of each of the LED light bars to the first power source and electrically connecting the negative terminals of the LED light bars to the light bar connection terminals of the constant current driving chip, each of the ninth to sixteenth terminals of the constant current driving chip being connected to one of the LED light bars;
(3) electrically connecting an end of each of the resistors to the respective resistor connection terminal of the constant current driving chip and connecting an opposite end to the grounding line, each of the twenty-fifth to thirty-two terminals of the constant current driving chip being connected to one of the resistors; and
(4) electrically connecting the power connection terminal and the power grounding line connection terminal of the constant current driving chip to the second power source and activating the first and second power sources to drive the plurality of LED light bars to give off light;
wherein the resistances of the plurality of resistors are determined according to the illumination of the LED light bar corresponding to each of the resistors;
wherein the resistors are formed of variable resistors;
wherein the LED light bars are of a number of 2-8 and the resistors have a number of 2-8 to correspond to that of the LED light bars; and
wherein the seventeenth to twenty-fourth terminals of the constant current driving chip are PWM control terminals, the PWM control terminals being externally connectable to control sources for controlling conduction or cutoff of the LED light bars

The efficacy of the present invention is that the present invention provides a method for using a constant current driving chip to generate different currents to drive light bars, which comprise resistors externally connected to current setting terminals of a constant current driving chip and having different resistances to form different currents for driving LED light bars and thus making the LED light bars generating different illuminations. The method is applicable to various fields, such as backlight driving of liquid crystal display device and LED lighting, to make various atmospheres through different visual effects perceived by human bodies. The present invention also provides an LED light bar driving circuit, which generates different electrical currents to drive light bars so as to make the light bars generating different illuminations and is applicable to various fields, such as backlight driving of liquid crystal display device and LED lighting, and is particularly applicable to various special occasions.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a circuit diagram of a constant current driving chip that drives light bars;

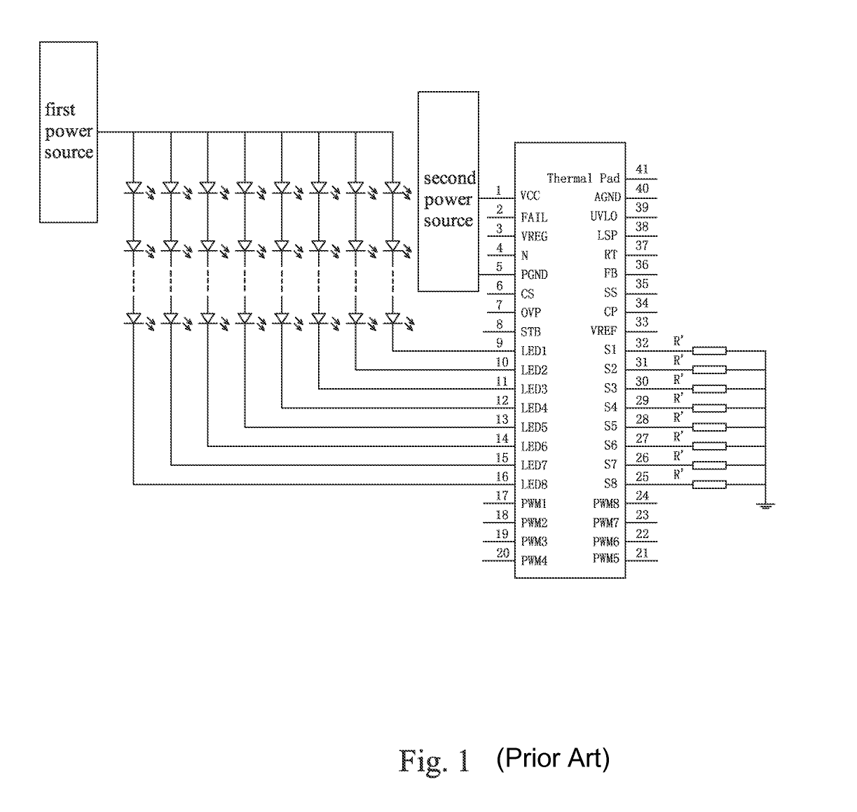

FIG. 2 is a flow chart illustrating a method for using a constant current driving chip to generate different currents to drive light bars according to the present invention; and

FIG. 3 is a circuit diagram of an LED light bar driving circuit according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

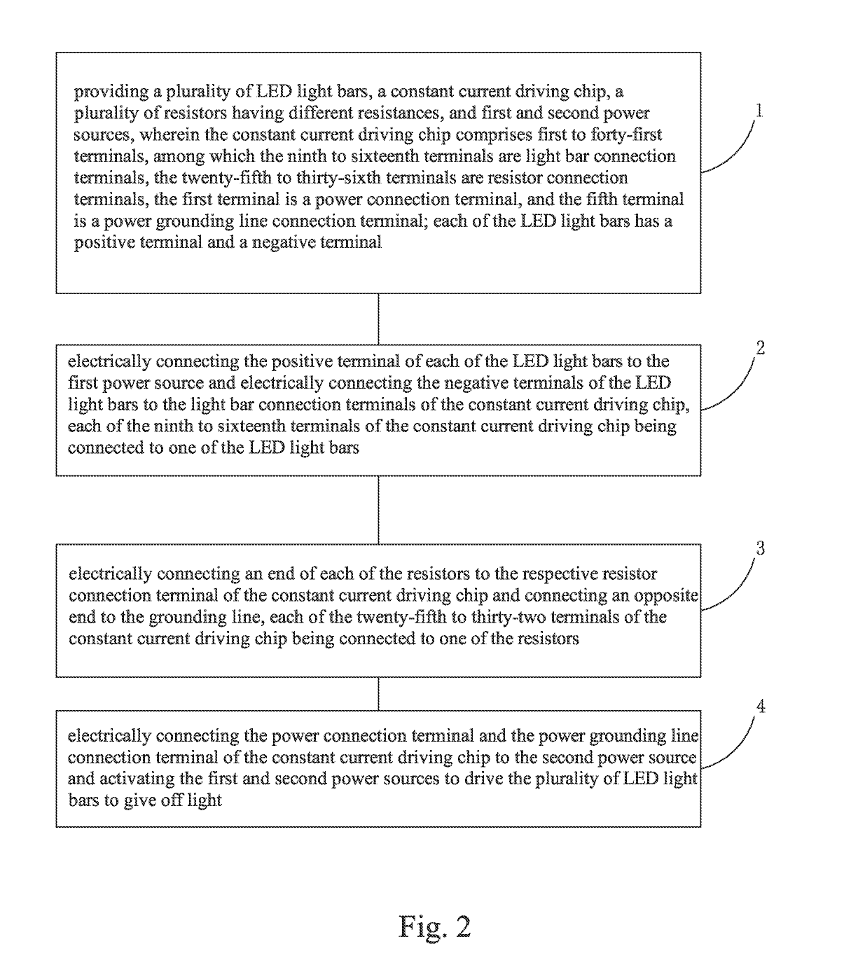

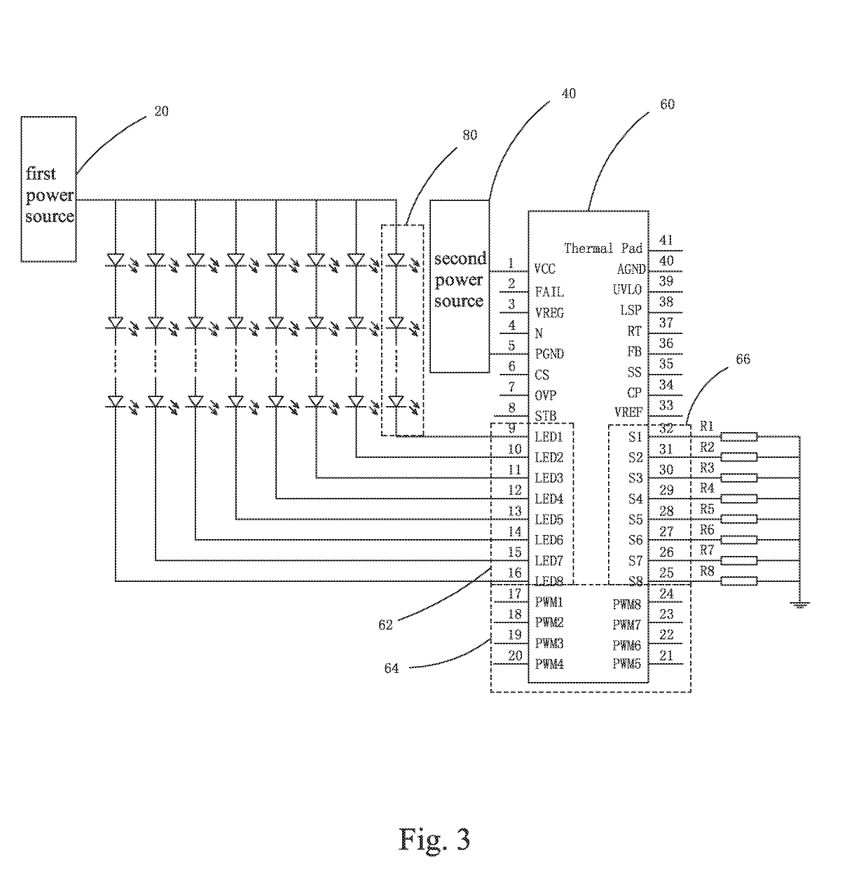

Referring to FIGS. 2 and 3, the present invention provides a method for using a constant current driving chip to generate different currents to drive light bars, which comprises the following steps:

Step 1: providing a plurality of LED light bars 80, a constant current driving chip 60, a plurality of resistors R1, R2, R3, . . . having different resistances, and first and second power sources 20, 40, wherein the constant current driving chip 60 comprises first to forty-first terminals, among which the ninth to sixteenth terminals are light bar connection terminals 62, the twenty-fifth to thirty-sixth terminals are resistor connection terminals 66, the first terminal 1 is a power connection terminal, and the fifth terminal 5 is a power grounding line connection terminal; each of the LED light bars 80 has a positive terminal and a negative terminal.

The resistances of the plurality of resistors R1, R2, R3, . . . are determined according to the illumination of the LED light bar 80 corresponding to each of the resistors R and in the instant preferred embodiment, various types of invariable resistors are selected according the determined resistances. The LED light bars 80 are of a number of 2-8 and the number of the resistors R is 2-8 to correspond to that of the LED light bars 80. In case that there are more LED light bars 80 to be driven, then a corresponding number of a constant current driving chip 60 may be added for driving.

The seventeenth to twenty-fourth terminals of the constant current driving chip 60 are PWM control terminals 64. The PWM control terminals 64 are externally connectable to control sources (not shown) for controlling the conduction or cutoff of the LED light bars 80. Each of the PWM control terminals 64 is provided to correspond each of the LED light bars 80 and each of the resistor connection terminals 66. A signal may be received through each of the PWM control terminals 64 to control the conduction or cutoff of the corresponding light bar 80.

Step 2: electrically connecting the positive terminal of each of the LED light bars 80 to the first power source 20 and electrically connecting the negative terminals of the LED light bars to the light bar connection terminals 62 of the constant current driving chip 60, each of the ninth to sixteenth terminals of the constant current driving chip 60 being connected to one of the LED light bars 80.

Step 3: electrically connecting an end of each of the resistors R to the respective resistor connection terminal 66 of the constant current driving chip 60 and connecting an opposite end to the grounding line, each of the twenty-fifth to thirty-two terminals of the constant current driving chip 60 being connected to one of the resistors R.

Each of the LED light bars 80, a control circuit contained in the constant current driving chip 60, and the respective resistor R collectively form a loop, whereby the difference of the resistances of the resistors R connected to the resistor connection terminals 66 of the constant current driving chip 60 (current setting terminals) allows each of the loops to have different current so as to provide different illumination of the LED light bars 80 for application in various sites for atmosphere making.

Step 4: electrically connecting the power connection terminal 1 and the power grounding line connection terminal 5 of the constant current driving chip 60 to the second power source 40 and activating the first and second power sources 20, 40 to drive the plurality of LED light bars 80 to give off light.

With the first and second power sources 20, 40, the PWM control terminals 64 may be used to control the conduction and cutoff of the LED light bars 80 in a safe and reliable manner.

This method is applicable to various fields, such as backlight driving of liquid crystal display device and LED lighting.

In another alternative preferred embodiment, the plurality of resistors R1, R2, R3, . . . is formed of variable resistors to make the resistors R connected to the constant current driving chip 60 more diversified to meet various needs.

Referring to FIG. 3, the present invention also provides an LED light bar driving circuit, which comprises a plurality of LED light bars 80, a constant current driving chip 60, a plurality of resistors R1, R2, R3, . . . having different resistances, and first and second power sources 20, 40. The constant current driving chip 60 comprises first to forty-first terminals, among which the ninth to sixteenth terminals are light bar connection terminals 62, the twenty-fifth to thirty-sixth terminals are resistor connection terminals 66, the first terminal 1 is a power connection terminal, and the fifth terminal 5 is a power grounding line connection terminal. The plurality of LED light bars 80 each has an end electrically connected to the first power source 20 and an opposite end electrically connected to the respective light bar connection terminal 62 and each of the ninth to sixteenth terminals is connected to one of the LED light bars 80. The plurality of resistors R1, R2, R3, . . . each has an end electrically connected to the grounding line and an opposite end electrically connected to the respective resistor connection terminal 66 and each of the twenty-fifth to thirty-sixth terminals is connected to one of the resistors. The power connection terminal and the power grounding line connection terminal are electrically connected to the second power source 40.

The resistances of the plurality of resistors R1, R2, R3, . . . are determined according to the illumination of the LED light bar 80 corresponding to each of the resistors R and in the instant preferred embodiment, various types of invariable resistors are selected according the determined resistances. The LED light bars 80 are of a number of 2-8 and the number of the resistors R are 2-8 to correspond to that of the LED light bars 80. In case that there are more LED light bars 80 to be driven, then a corresponding number of a constant current driving chip 60 may be added for driving.

The seventeenth to twenty-fourth terminals of the constant current driving chip 60 are PWM control terminals 64. The PWM control terminals 64 are externally connectable to control sources (not shown) for controlling the conduction or cutoff of the LED light bars 80. Each of the PWM control terminals 64 is provided to correspond each of the LED light bars 80 and each of the resistor connection terminals 66. A signal may be received through each of the PWM control terminals 64 to control the conduction or cutoff of the corresponding light bar 80.

Each of the LED light bars 80, a control circuit contained in the constant current driving chip 60, and the respective resistor R collectively form a loop, whereby the difference of the resistances of the resistors R connected to the resistor connection terminals 66 of the constant current driving chip 60 (current setting terminals) allows each of the loops to have different current so as to provide different illumination of the LED light bars 80 for application in various sites for atmosphere making.

The driving circuit is applicable to various fields, such as backlight driving of liquid crystal display device and LED lighting.

In another alternative preferred embodiment, the plurality of resistors R1, R2, R3, . . . is formed of variable resistors to make the resistors R connected to the constant current driving chip 60 more diversified to meet various needs.

In summary, the present invention provides a method for using a constant current driving chip to generate different currents to drive light bars, which comprise resistors externally connected to current setting terminals of a constant current driving chip and having different resistances to form different currents for driving LED light bars and thus making the LED light bars generating different illuminations. The method is applicable to various fields, such as backlight driving of liquid crystal display device and LED lighting, to make various atmospheres through different visual effects perceived by human bodies. The present invention also provides an LED light bar driving circuit, which generates different electrical currents to drive light bars so as to make the light bars generating different illuminations and is applicable to various fields, such as backlight driving of liquid crystal display device and LED lighting, and is particularly applicable to various special occasions.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for using a constant current driving chip to generate different currents to drive light bars, comprising the following steps:
(1) providing a plurality of light emitting diode (LED) light bars, a constant current driving chip, a plurality of resistors having different resistances, and first and second power sources, wherein the constant current driving chip comprises first to forty-first terminals, among which the ninth to sixteenth terminals are light bar connection terminals, the twenty-fifth to thirty-sixth terminals are resistor connection terminals, the first terminal is a power connection terminal, and the fifth terminal is a power grounding line connection terminal; each of the LED light bars has a positive terminal and a negative terminal;
(2) electrically connecting the positive terminal of each of the LED light bars to the first power source and electrically connecting the negative terminals of the LED light bars to the light bar connection terminals of the constant current driving chip, each of the ninth to sixteenth terminals of the constant current driving chip being connected to one of the LED light bars;
(3) electrically connecting an end of each of the resistors to the respective resistor connection terminal of the constant current driving chip and connecting an opposite end to the grounding line, each of the twenty-fifth to thirty-two terminals of the constant current driving chip being connected to one of the resistors; and
(4) electrically connecting the power connection terminal and the power grounding line connection terminal of the constant current driving chip to the second power source and activating the first and second power sources to drive the plurality of LED light bars to give off light.

2. The method for using a constant current driving chip to generate different currents to drive light bars as claimed in claim 1, wherein the resistances of the plurality of resistors are determined according to the illumination of the LED light bar corresponding to each of the resistors.

3. The method for using a constant current driving chip to generate different currents to drive light bars as claimed in claim 2, wherein the resistors are formed of variable resistors.

4. The method for using a constant current driving chip to generate different currents to drive light bars as claimed in claim 3, wherein the LED light bars are of a number of 2-8 and the resistors have a number of 2-8 to correspond to that of the LED light bars.

5. The method for using a constant current driving chip to generate different currents to drive light bars as claimed in claim 1, wherein the seventeenth to twenty-fourth terminals of the constant current driving chip are PWM control terminals, the PWM control terminals being externally connectable to control sources for controlling conduction or cutoff of the LED light bars.

6. An LED (light emitting diode) light bar driving circuit, comprising a plurality of LED light bars, a constant current driving chip, a plurality of resistors having different resistances, and first and second power sources, the constant current driving chip comprising first to forty-first terminals, among which the ninth to sixteenth terminals are light bar connection terminals, the twenty-fifth to thirty-sixth terminals are resistor connection terminals, the first terminal is a power connection terminal, and the fifth terminal is a power grounding line connection terminal, the plurality of LED light bars each having an end electrically connected to the first power source and an opposite end electrically connected to the respective light bar connection terminal, each of the ninth to sixteenth terminals being connected to one of the LED light bars, the plurality of resistors each having an end electrically connected to the grounding line and an opposite end electrically connected to the respective resistor connection terminal, each of the twenty-fifth to thirty-sixth terminals being connected to one of the resistors, the power connection terminal and the power grounding line connection terminal being electrically connected to the second power source.

7. The LED light bar driving circuit as claimed in claim 6, wherein the resistances of the plurality of resistors are determined according to the illumination of the LED light bar corresponding to each of the resistors.

8. The LED light bar driving circuit as claimed in claim 7, wherein the resistors are formed of variable resistors.

9. The LED light bar driving circuit as claimed in claim 6, wherein the LED light bars are of a number of 2-8 and the resistors have a number of 2-8 to correspond to that of the LED light bars.

10. The LED light bar driving circuit as claimed in claim 6, wherein the seventeenth to twenty-fourth terminals of the constant current driving chip are PWM control terminals, the PWM control terminals being externally connectable to control sources for controlling conduction or cutoff of the LED light bars.

11. A method for using a constant current driving chip to generate different currents to drive light bars, comprising the following steps:
(1) providing a plurality of LED light bars, a constant current driving chip, a plurality of resistors having different resistances, and first and second power sources, wherein the constant current driving chip comprises first to forty-first terminals, among which the ninth to sixteenth terminals are light bar connection terminals, the twenty-fifth to thirty-sixth terminals are resistor connection terminals, the first terminal is a power connection terminal, and the fifth terminal is a power grounding line connection terminal; each of the LED light bars has a positive terminal and a negative terminal;
(2) electrically connecting the positive terminal of each of the LED light bars to the first power source and electrically connecting the negative terminals of the LED light bars to the light bar connection terminals of the constant current driving chip, each of the ninth to sixteenth terminals of the constant current driving chip being connected to one of the LED light bars;
(3) electrically connecting an end of each of the resistors to the respective resistor connection terminal of the constant current driving chip and connecting an opposite end to the grounding line, each of the twenty-fifth to thirty-two terminals of the constant current driving chip being connected to one of the resistors; and
(4) electrically connecting the power connection terminal and the power grounding line connection terminal of the constant current driving chip to the second power source and activating the first and second power sources to drive the plurality of LED light bars to give off light;
wherein the resistances of the plurality of resistors are determined according to the illumination of the LED light bar corresponding to each of the resistors;
wherein the resistors are formed of variable resistors;
wherein the LED light bars are of a number of 2-8 and the resistors have a number of 2-8 to correspond to that of the LED light bars; and
wherein the seventeenth to twenty-fourth terminals of the constant current driving chip are PWM control terminals, the PWM control terminals being externally connectable to control sources for controlling conduction or cutoff of the LED light bars.
